(19) United States
(12) Patent Application Publication
(10) Pub. No.: US 2020/0337449 A1
(43) Pub. Date: Oct. 29, 2020

(54) Devices for Drying a Brush and Methods of Operating the Same

(71) Applicant: Michael McCall, Nashville, TN (US)

(72) Inventor: Michael McCall, Nashville, TN (US)

(21) Appl. No.: 16/392,552

(22) Filed: Apr. 23, 2019

(51) Int. Cl. A46B 17/06

(52) U.S. Cl. CPC A46B 17/06; B44D 3/006

(57) ABSTRACT

A device for drying the bristles of a brush, the device including a body with an air-moving component; and a brush holder, the brush holder configured to hold at least one brush substantially horizontal and, further, so that the bristles of the brush are in the flow of air from the air-moving component.

A device for drying the bristles of a brush, the device including a body with an air-moving component, and a brush holder, the brush holder configured to hold at least one brush at an angle of up to 35 degrees from a horizontal plane and, further, so that the bristles of the brush are in the flow of air form the air-moving component.

### CROSS-REFERENCE TO RELATED APPLICATION

None.

### STATEMENT REGARDING FEDERALLY SPONSORED RESEARCH & DEVELOPMENT

None.

### FIELD OF THE INVENTION

The invention relates to a device for drying brushes.

### BACKGROUND OF THE INVENTION

Brushes are commonly used in a variety of applications. For example, make-up brushes may be used to apply make-up to a person or object, artist paint brushes may be used to paint pictures or other artistic works, and painters may use industrial paint brushes to paint a building or object. However, it is generally difficult to easily and effectively dry brushes after cleaning for reuse. It would be highly desirable to improve the drying capabilities and ease of use of today's brush drying devices.

### SUMMARY OF THE INVENTION

A device for drying the bristles of a brush, the device including a body with an air-moving component, and a brush holder, the brush holder configured to hold at least one brush substantially horizontal and, further, so that the bristles of the brush are in the flow of air from the air-moving component.

A device for drying the bristles of a brush, the device including a body with an air-moving component, and a brush holder, the brush holder configured to hold at least one brush at an angle of up to approximately 35 degrees from a horizontal plane and, further, so that the bristles of the brush are in the flow of air from the air-moving component.

### DESCRIPTION OF THE FIGURES

FIG. 1 is a first perspective view of a first embodiment of a brush dryer according to the invention.

FIG. 2 is a front view of the embodiment of the brush dryer of FIG. 1.

FIG. 3 is a rear view of the embodiment of the brush dryer of FIG. 1.

FIG. 4 is a side view of a first side of the embodiment of the brush dryer of FIG. 1.

FIG. 5 is a top view of the embodiment of the brush dryer of FIG. 1.

FIG. 6 is a bottom view of the embodiment of the brush dryer of FIG. 1.

FIG. 7 is a cross-sectional top view of the embodiment of the brush dryer of FIG. 1.

FIG. 8 is a top view of a second embodiment of a brush dryer according to the invention.

FIG. 9 is a front view of the second embodiment of the brush dryer of FIG. 8.

FIG. 10 is a cross-sectional side view of the second embodiment of the brush dryer of FIG. 8.

### DETAILED DESCRIPTION

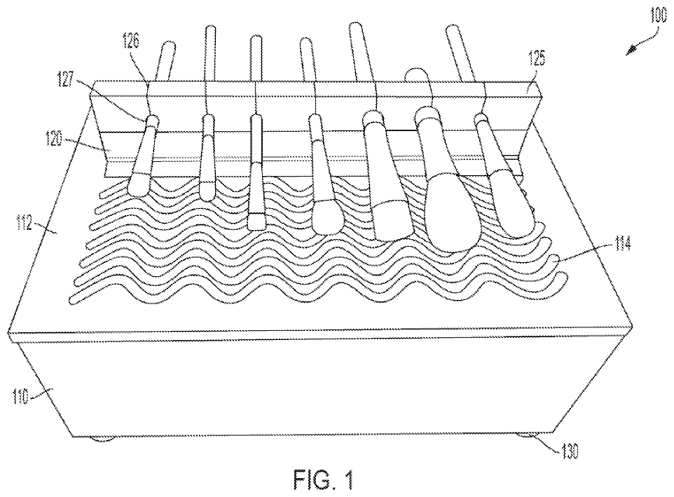

FIG. 1 shows a perspective view of an embodiment of a device 100 for drying a brush. Device 100 includes body 110 with top surface 112. Top surface 112 includes openings 114. In this embodiment, device 100 is configured so that air passes upward through openings 114. In this embodiment, the air is warmed prior to passing upward through openings 114. In alternative embodiments, the temperature and/or humidity of the air are set so that the device 100 can dry wet brushes without damaging or with minimal damage to the brushes.

Top surface 112 includes support 120. Support 120 includes brush holder 125. In this embodiment, support 120 is a bracket for holding brush holder 125. In this embodiment, brush holder 125 may be easily changed for replacing brush holder 125 when it becomes warn and/or dirty. In alternative embodiments, support 120 may comprise almost any structure capable of supporting a brush holder. In still further embodiments, body 110 may support brush holder 125 itself by, for example, including a recess for placing brush holder 125. In alternative embodiments, brush holder 125 may support itself. In still further embodiments, one or more of support 120 and brush holder 125 may be unitary with body 110. In additional alternative embodiments, brush holder 125 may be affixed to or supported directly on body 110 without the need for support 120.

In this embodiment, brush holder 125 is made of a soft material and includes slits 126 and brush openings 127. In use, a user of device 100 slides a brush into one of brush openings 127. Brush openings 127 are configured so that when a brush is slid into a brush opening 127, the brush opening 127 can accommodate a brush and firmly hold the brush in place. Slits 126 allow for some expansion of brush openings 127 to allow brush openings 127 some variation in the brushes it can hold. In this embodiment, brush openings 127 are at least two different sizes to accommodate different sized brushes. In alternative embodiments, all of brush openings 127 are the same size. In this embodiment, brush openings 127 are configured to hold the brushes in a substantially horizontal position. Further, brush holder 125 may be sized and configured to hold the brush bristles that are to be dried at a certain distance from top surface 112. In some embodiments, brush holder 125 is sized and configured to hold the brush bristles between approximately ⅛ an inch and approximately 10 inches over top surface 112, and in more preferred embodiments, between approximately ½ an inch and 4 inches over top surface 112. Preferred spacing allows device 100 to effectively dry the brush bristles while minimizing damage to the brush bristles from overheating, where heated air is used. Different types of brushes and different sizes of brushes may have different spacing preferences, which may differ from those discussed above. In this view only, brushes are shown in brush openings 127.

Feet 130 are located on the bottom of body 110. Feet 130 elevate body 110 so that air may enter body 110 from underneath body 110 when device 100 is placed on a flat surface.

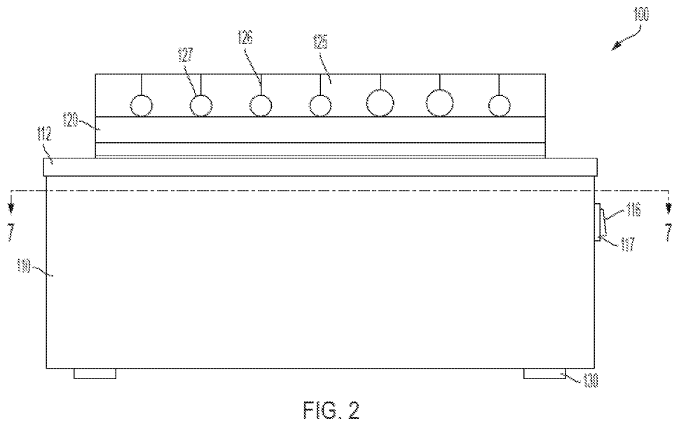

FIG. 2 is a front view of device 100. Device 100 include body 110 with top surface 112, support 120, and brush holder 125. Brush holder 125 includes slits 126 and brush openings 127 for holding brushes. Located on the bottom of body 110 are feet 130. As can be seen in FIG. 2, body 110 includes on/off switch 116. In this embodiment, on/off switch 116 includes a timer 117 so that device 100 turns off after a set amount of time. The use of timer 117 limits damage to the bristles of the brush from being unnecessarily exposed to warmed and/or dry air. In alternative embodiments, timer 117 can be set by a user of device 100. In still further embodiments, timer 117 does not automatically switch off on/off switch 116 upon the expiration of a given amount of time but, instead, indicates that the given amount of time has passed. For example, timer 117 may emit a sound or light indication to indicate that device 100 has performed the drying function for 20 minutes. The user of device 100 could then examine the brushes to determine whether to turn device 100 off or whether further drying was needed. In alternative embodiments, the indicator may be a separate component of device 100.

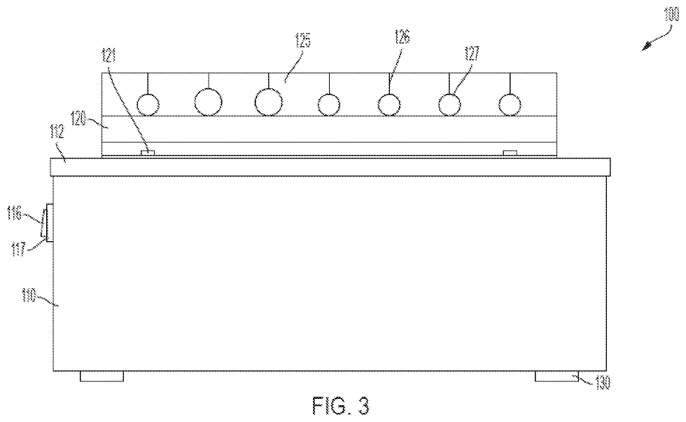

FIG. 3 is a rear view of device 100. Holding support 120 to body 110 are screws 121.

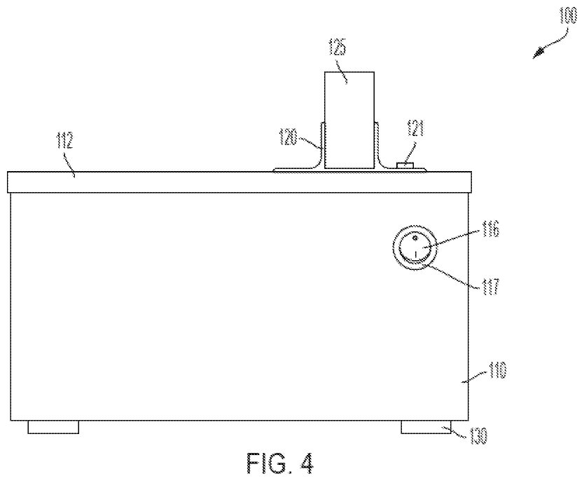

FIG. 4 is a side view of device 100.

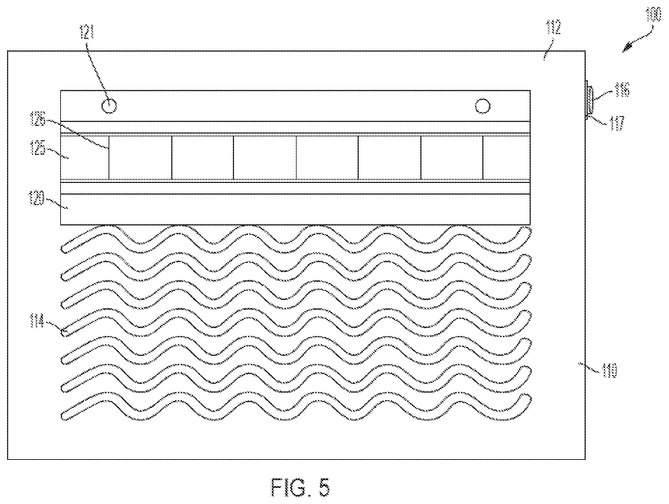

FIG. 5 is a top view of device 100.

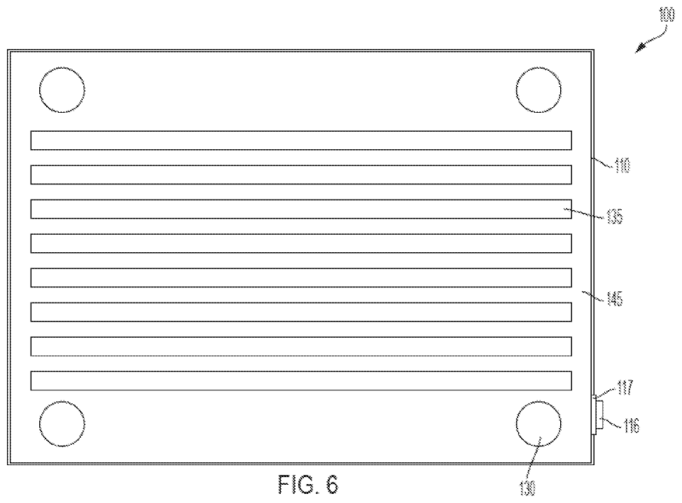

FIG. 6 is a bottom view of device 100. Feet 130 keep body 110 off the surface upon which device 100 is placed. Vents 135 on bottom surface 145 of body 110 allow air to easily enter body 110. In alternative embodiments, bottom surface 145 does not include feet 130 or vents 135. In these embodiments, device 100 can be placed on a surface and air enters body 110 through a surface of body 110 other than bottom surface 145.

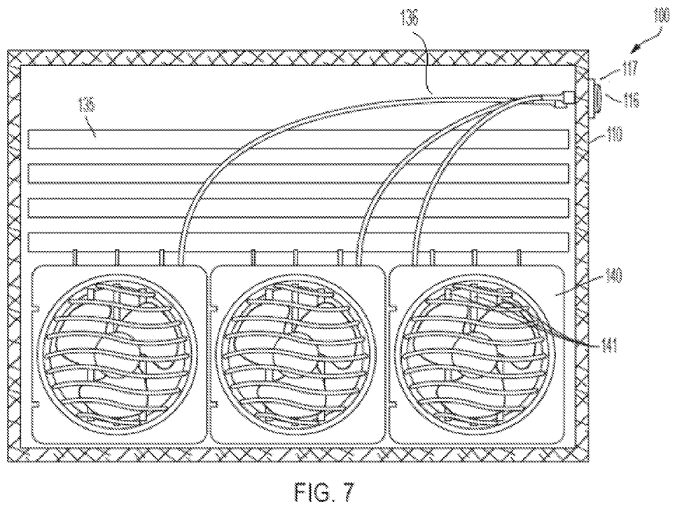

FIG. 7 is a cross sectional top view of device 100 looking into body 110. Inside body 110 are three fans 140 for moving air. Fans 140 include heating elements 141 for heating the air that is being moved by fans 140. Fans 140 are connected to on/off switch 116 by wires 136.

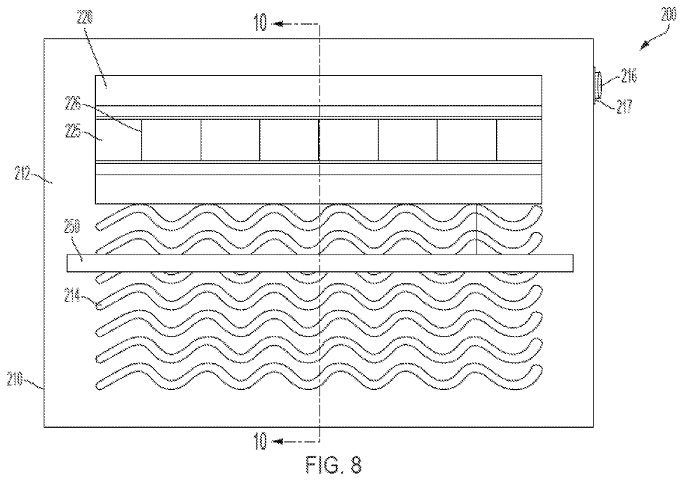

FIG. 8 is a top view of an embodiment of a device 200 of the present invention. Device 200 comprises a body 210 with a top surface 212. Top surface 212 includes openings 214. In this embodiment, device 200 is configured so that air passes upward through openings 214.

Top surface 212 includes support 220. Support 220 includes brush holder 225. In this embodiment, support 220 is a bracket for holding brush holder 225. Brush holder 225 includes slits 226. Top surface 212 also includes ultraviolet light 250 for disinfecting brushes in brush holder 225. Device 200 also includes on/off switch 216 and timer 217.

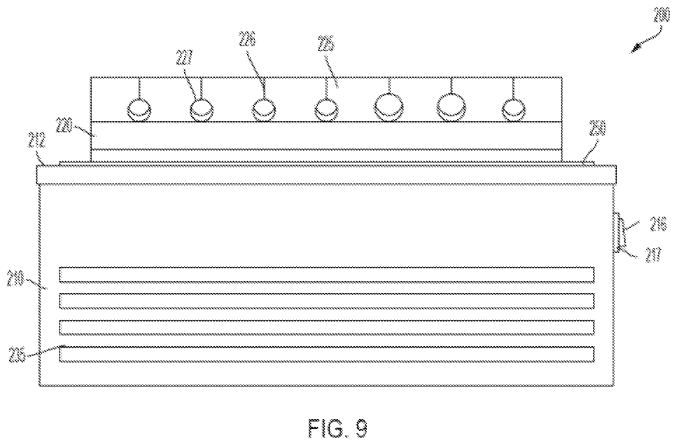

FIG. 9 is a front view of device 200. Vents 235 on body 210 allow air to easily enter body 210. In this embodiment, brush holder 225 is made of a soft material and includes slits 226 and brush openings 227. In use, a user of device 200 slides a brush into brush openings 227 where the brush is held firmly in place. Slits 226 allow for some expansion of brush openings 227 so that brush openings 227 can accept brushes of various sizes.

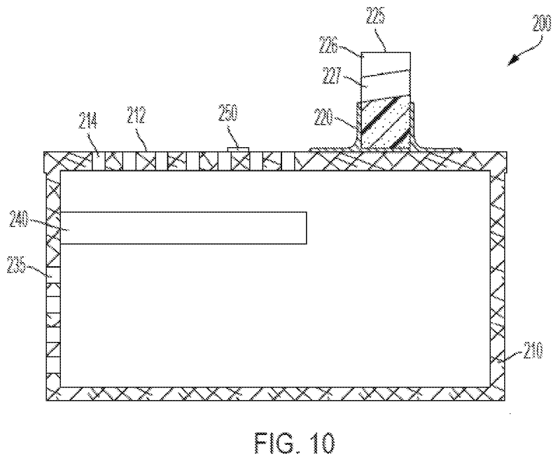

FIG. 10 is a cross sectional side view of device 200. In this embodiment, brush openings 227 are angled to hold the brushes so that their handles are elevated. Generally, the brushes are held at an angle of up to approximately 35 degrees from the horizontal plane. Holding the brushes at such an angle prevents moisture from traveling toward and potentially damaging the ferrule and handle of the brush. Device 200 also includes a fan element 240 for moving air in through vents 235 and up through openings 214 towards the brush bristles that are to be dried.

1-20. (canceled)

21. A device for drying bristles of a brush, the device comprising:
a housing comprising a bottom configured to face the ground, a top opposite the bottom, a height extending from the top to the bottom, a width perpendicular to the height, a length perpendicular to the width and height, an interior, a fan, an air inlet configured to allow air to enter the interior, and an air outlet located on the housing top and configured to allow air to exit the interior;
a panel extending generally upward from the housing top and comprising a panel top, a panel bottom, a panel height extending from the panel top to the panel bottom, a panel width, and a panel thickness, the panel further comprising a plurality of brush openings located below the panel top, the plurality of brush openings distributed about the panel width, the brush openings having a width parallel to the panel width, the brush openings extending through the panel thickness,
wherein the device further comprises a plurality of brushes positioned above the housing top, each brush comprising bristles positioned over the air outlet, a shaft positioned in a brush opening, a rear end opposite the bristles and a brush length extending from the rear end to the bristles of the respective brush, and further wherein the lengths of the plurality of brushes are oriented generally perpendicular to the panel width.

22. The device of claim 21 wherein at least some of the brush openings have different widths.

23. The device of claim 21 wherein the lengths of the plurality of brushes are oriented generally perpendicular to the housing width, and further wherein the panel width is parallel to the housing width.

24. The device of claim 21 wherein the rear end of each brush is located above the bristles of the respective brush.

25. The device of claim 21 wherein each brush opening comprises an opening front, an opening back, and an opening length extending from the opening front to the opening back and further wherein the opening back is located above the opening front for each respective opening.

26. The device of claim 21 wherein the air outlet comprises a plurality of wave-shaped vents located on the housing top.

27. The device of claim 26 wherein the air inlet comprises a plurality of rectangular-shaped vents located on the housing bottom.

28. The device of claim 26 wherein the housing further comprises a front, and a back, the housing length extending from the front to the back, and further wherein the air inlet comprises a plurality of rectangular-shaped vents located on the housing front.

29. The device of claim 28 wherein the interior comprises the fan, and further wherein the fan is located above the plurality of rectangular-shaped vents located on the housing front and directly below the plurality of wave-shaped vents located on the housing top.

30. The device of claim 21 wherein the air outlet comprises a plurality of non-linear vents located on the housing top.

31. The device of claim 21 wherein the housing bottom comprises a plurality of feet extending downwardly from the housing bottom and further wherein the air inlet is located in the housing bottom.

32. The device of claim 21 wherein the interior further comprises a heater.

33. The device of claim 21 wherein the panel is removable from the housing.

34. The device of claim 21 wherein the device further comprises an ultraviolet light.

35. The device of claim 21 further comprising a timer configured to control the fan.

36. The device of claim 21 wherein the plurality of brush openings are located between about 0.5 inches to about 4 inches above the housing top.

37. The device of claim 21 wherein the panel width is parallel to the housing width and the panel thickness is parallel to the housing length.

38. The device of claim 21 wherein the interior comprises the fan.
